(19) United States
(12) Patent Application Publication
(10) Pub. No.: US 2020/0085024 A1
(43) Pub. Date: Mar. 19, 2020

(54) STATIC PROGRAMMABLE ELECTRO-CHROMIC FISHING LURE

(71) Applicant: NEWTONOID TECHNOLOGIES, L.L.C., Liberty, MO (US)

(72) Inventors: FIELDING B. STATON, LIBERTY, MO (US); DAVID STRUMPF, COLUMBIA, MO (US)

(21) Appl. No.: 16/570,943

(22) Filed: Sep. 13, 2019

Related U.S. Application Data
(60) Provisional application No. 62/730,920, filed on Sep. 13, 2018.

(51) Int. Cl. A01K 85/01

(52) U.S. Cl. CPC A01K 85/01; A01K 2227/40

(57) ABSTRACT

A fishing lure system includes a body having a line attachment portion and a hook and a first static programmable electro-chromic (SPEC) particle panel adjacent the body. The first SPEC particle panel is selectively changeable between a first color and a second color in response to a first stimulus.

### CROSS-REFERENCE TO RELATED APPLICATIONS

This application claims priority to U.S. Provisional Patent Application No. 62/730,920, filed Sep. 13, 2018, the entire disclosure of which is incorporated by reference herein.

### FIELD OF THE DISCLOSURE

The disclosure relates generally to the field of fishing lures. More specifically, the disclosure relates to the field of fishing lures with color changing static programmable electro chromic particle panels.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In one embodiment, a fishing lure system includes a fishing lure body having a line attachment portion and a hook and a first static programmable electro-chromic (SPEC) particle panel adjacent the body. The first SPEC particle panel is selectively changeable between a first color and a second color in response to a first stimulus.

According to another embodiment, a fishing lure system includes a body having a first static programmable electro-chromic (SPEC) particle panel selectively changeable between a first color and a second color; and a receptacle configured to receive the body, the receptacle having an actuator. The first SPEC particle panel changes between the first and the second color in response to a first stimulus, and the actuator is configured to apply the first stimulus to the first SPEC particle panel.

According to still another embodiment, a method of operating a fishing lure system includes first providing a fishing lure having a body comprising a first static programmable electro-chromic (SPEC) particle panel selectively changeable between a first color and a second color in response to a stimulus. A receptacle configured to house the body is further provided. The receptacle has an actuator for actuating a first stimulus. The body is placed within the receptacle, and the first stimulus is actuated to initiate the first SPEC particle panel change from the first color to the second color. The body is then removed from the receptacle.

### BRIEF DESCRIPTION OF THE SEVERAL VIEWS OF THE DRAWINGS

Illustrative embodiments of the present disclosure are described in detail below with reference to the attached drawing figures.

FIG. 1 is a side view of an embodiment of a fishing lure.

FIG. 2 is a detailed side view of an embodiment of a static programmable electro-chromic (SPEC) particle panel used in the fishing lure of FIG. 1.

FIG. 3 is a perspective view of an embodiment of a receptacle used with the fishing lure of FIG. 1.

FIG. 4 is a flowchart depicting a method for using the receptacle of FIG. 3 with the fishing lure of FIG. 1.

### DETAILED DESCRIPTION

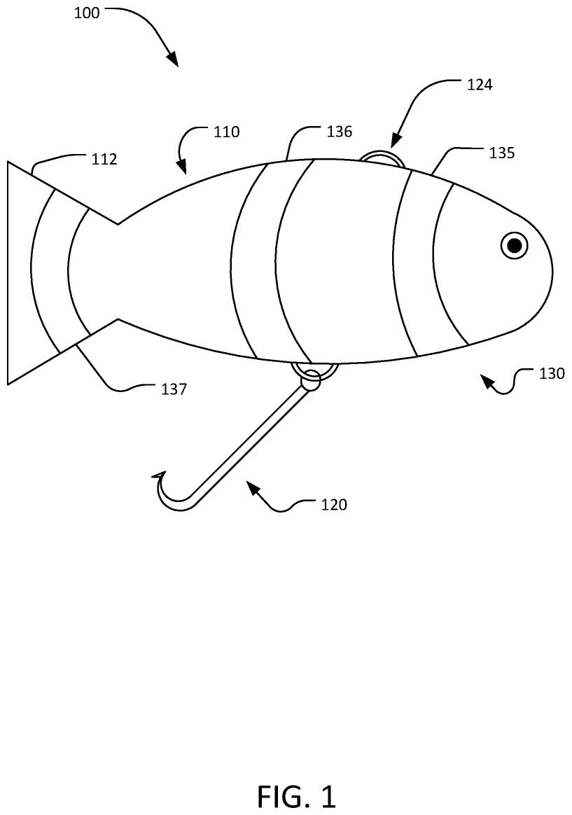

As shown if FIGS. 1-3, a fishing lure 100 broadly includes a body 110, a hook 120, and one or more static programmable electro-chromic (SPEC) particle panels 130. The SPEC particle panels 130 of the fishing lure 100 may be selectively changeable (e.g., in reaction to a stimulus) from a first state (where the SPEC particle panel 130 displays a first color) to a second state (where the SPEC particle panel 130 displays a second color). As will be described in greater detail below, the fishing lure 100 may utilize a receptacle 140 to provide the stimulus to initiate the change from the first state to the second state, although other means for providing stimulus may additionally or alternately be used. In this manner, the fishing lure 100 may be selectively changed to a user desired aesthetic appearance. Thus, the fishing lure 100 may be adjusted to adapt to the environmental conditions (e.g., water depth, weather, lighting, fish to be caught, etc.) in which the user wishes to use the fishing lure 100, the fish the user is targeting, or simply to change the look of the lure.

The body 110 may include a hull 112, which may be made of a resilient material (e.g., wood, metal, plastic, rubber, ceramic, fiberglass, carbon fiber, silicone, epoxy, et cetera). The hull 112 may be further configured to have the aesthetic appearance of a type of prey or bait, which shape may be determined based on the aesthetic appearance of the type of fish that one wishes to catch. For example, the aesthetic appearance may have surface coloring and/or patterns resembling a minnow to attract fish that commonly eat minnows. As another example, the aesthetic appearance may have surface coloring and/or patterns resembling a frog to attract fish that commonly eat frogs. The aesthetic appearance may be represented via the overall shape of the hull 112, protrusions from the hull 112 (i.e., fins, legs, etc.), and/or other added detail (e.g., eyes, scales, tails, feathers, gills, stripes, et cetera). In operation, the hull 112 may have a configuration that is the same or similar to fishing lures now known or subsequently developed (e.g., a spinner, spoon, popper, jig, swimbait, crankbait, plug, wobbler, surface lure, an artificial worm or fly, et cetera).

As seen in FIG. 1, there may be one or more hooks 120 attached to or formed as part of the hull 112. Each of the hooks 120 may be a single or multi-hook (e.g., double, treble, et cetera). In some embodiments, there may be a plurality of locations along the hull 112 where the hooks 120 are attached. It is to be understood that any suitable kind of fishing hook now known or subsequently developed may be included within the scope of the disclosure. In some embodiments, there may be additional aesthetic detail added to the hook 120, such as a feather, a jig, additional coloring, fuzz, a skirt, blades, et cetera.

The fishing lure 100 may have a line attachment portion 122 for coupling the fishing lure 100 to a line (e.g., a fishing line). The line attachment portion 122 may include one or more rings that are attached (e.g., hingedly attached) to the hull 112. The line attachment portion 122 may be arranged along an upper surface of the hull 112, though any other suitable hull 112 location is contemplated. In operation, the user may use the line attachment portion 122 to tie (or otherwise attach) the fishing lure 100 to the fishing line. Accordingly, the user may be able to repeatedly cast out and retrieve the fishing lure 100 from a body of water.

It is to be understood that the location of the line attachment portion 122 may influence the movement of the fishing lure 100 through a body of water, and as such, many different arrangements of the line attachment portion 122 along the body 110 are contemplated herein. For example, a line attachment portion 122 located near the head of a fishing lure 100 may emulate the movements of a live swimming fish when the fishing lure 100 is pulled through a body of water by the fishing line. As another example, the line attachment portion 122 may be attached to an offset a distance from hull 112, similar to some spinner baits known in the art.

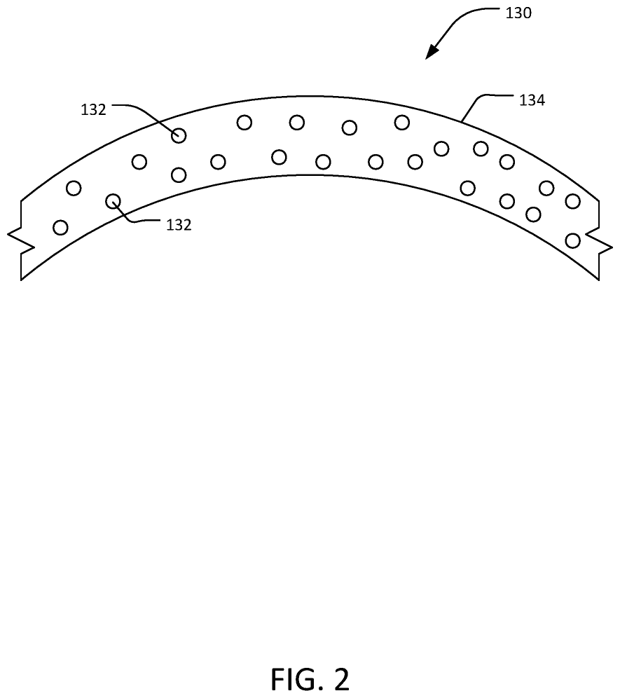

Turning now to FIG. 2, the SPEC particle panels 130, which form at least a portion of the body 110, may have a plurality of SPEC particles 132 disposed within a carrier 134 (e.g., a container, a capsule, a panel, et cetera). The SPEC particles 132 may have two-dimensional and/or three-dimensional appearance changing properties (i.e., one or more properties that causes a change in the color of the SPEC particles 132 in reaction to stimuli), such as electrochromic, photochromic, thermochromic, magnetochromic, electroluminescent, and/or other similar properties. The SPEC particles 132 may include components such as ink, light emitting diodes (LEDs), organic LEDs, metamaterial polymers, nitinol, ferrofluids, carbon nanotubes (CNT), or other similar attribute changing components. In operation, the SPEC particles 132 may be configured to switch between a first color and a second color in response to a stimulus or trigger. Each of the plurality of SPEC particles 132 may have a microcapsule containing one or more pigmented portions that respond to some sort of stimuli, causing the apparent color of the ink (or other colored components) to change. In embodiments, the SPEC particles 132 may have one or more fibers and/or smart polymers configured to change color in response to a stimulus, such as poly propyl (acrylic acid), poly(ethacrylic acid), PMMA-PEG copolymer, polysilamine, poly(4-vinylpyridine), poly(2-vinylpyridine), poly(2-diethylaminoethyl methacrylate), et cetera.

The SPEC particles 132 may form a non-volatile, semi-permanent “ink” that responds to electrical (or other) stimulation to switch between a first and a second color. The ink may be considered semi-permanent because once the SPEC particles 132 have switched (e.g., from the first color to the second color), the SPEC particles 132 remain in that state until a stimulus or trigger causes the SPEC particles 132 to switch back (e.g., from the second color to the first color). This semi-permanent attribute that the SPEC particles 132 exhibit differ from typical color changing or color displaying features of prior art fishing lures, because the SPEC particles 132 may require little to no energy to remain in their state once changed.

Types of stimuli that may induce a change in color from the SPEC particles 132 may include, for example, temperature, electric impulses, magnetic fields, pH, wavelength/intensity of impinging light, et cetera. While SPEC particles 132 that change between two colors are primarily discussed herein, it is to be understood that the SPEC particles 132 may change between three or more colors.

As noted above, in embodiments, the state change of the stimuli-responsive SPEC particles 132, once triggered, may be permanent. Such stimuli-responsive SPEC particles 132 may be referred to herein as irreversible SPEC particles 132. Conversely, reversible SPEC particles 132 may be configured to change their color state multiple times in response to stimuli. For instance, a SPEC particle panel 130 with reversible SPEC particles 132 having magnetochromic properties may change from a first color to a second color due to an induced magnetic field, and subsequently change back from the second color to the first after being introduced to another magnetic field. In embodiments, one or more SPEC particle panels 130 may include both reversible and irreversible SPEC particles 132.

One or more of these color changing SPEC particle panels 130 may define a portion of the body 110. The SPEC particle panels 130 may be attached to or form a part of the body 110, or more specifically, the hull 112. In embodiments, the SPEC particle panels 130 may be incorporated within the hull 112. For instance, the hull 112 may be configured to have a translucent or transparent appearance, and the SPEC particle panels 130 may be disposed within the body 110. As another example, one or more SPEC particle panels 130 may make up the “head” (e.g., eyes, nose, mouth, etc.) of the hull 112.

In some embodiments, one or more of the SPEC particle panels 130 may be separable from the hull 112. Separable SPEC particle panels 130 may be readily interchangeable (e.g., via adhesive, fasteners, screws, nails, bolt, clips, magnets, hook and loop fasteners, etc.) with other SPEC particle panels 130, which may allow for relatively easy repair and/or replacement of a faulty SPEC particle panel. Furthermore, interchanging SPEC particle panels 130 may allow a user to customize the appearance of the fishing lure 100. For example, the user may switch out a first SPEC particle panel 130 (e.g., that switches between a black color and a white color) with a second SPEC particle panel 130 (e.g., that switches between a green color and a red color). In this manner, the user may readily adapt the fishing lure 100 to a wide variety of fishing situations and environmental conditions, especially when compared to non-SPEC particle panel fishing lures known in the art.

As discussed above, there may be a plurality of SPEC particle panels 130 used in the fishing lure 100. In such embodiments, one or more of the SPEC particle panels 130 may have at least one color different from at least one other SPEC particle panel 130. For example, the hull 112, may include a first panel 135, a second panel 136, and a third panel 137, arranged on a head, body, and tail of a fish, respectively (FIG. 1). The first panel 135 may be configured to switch between white and grey, for example; the second panel 136 may be configured to switch between red and orange, for example; and the third panel 137 may be configured to switch between yellow and green, for example. Each of the plurality of panels 130 may be configured to react to the same type of stimulus, or at least one of the panels 130 may be configured to react to a different type of stimulus from at least one other panel 130. For example, the first panel 135 may react to temperature stimuli, the second panel 136 may also react to temperature, while the third panel 137 may react to an electrical or magnetic stimulus.

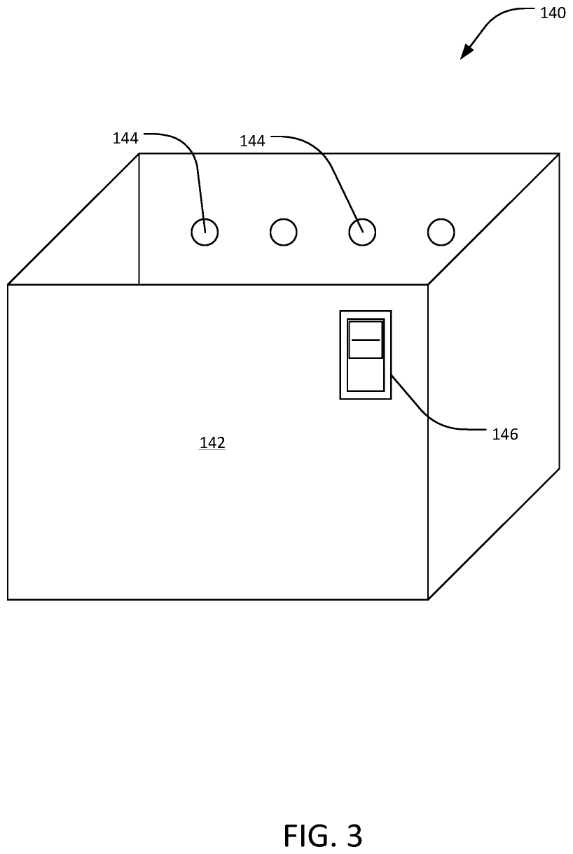

A receptacle 140 may include a vessel 142 (e.g., a container, box, cup, bowl, et cetera) with an actuator 144 (FIG. 3) configured to persuade a reaction from the SPEC particles 132. The actuator 144 may vary depending upon what type of SPEC particles 132 are incorporated within an embodiment of the fishing lure 100. For example, the actuator 144 may include magnets and/or electromagnets for use with SPEC particles 132 that are configured to react to a magnetic field. As another example, the actuator 144 may include a power supply and electrical contacts for use with SPEC particles 132 that are configured to react to an electric impulse. In yet another example, the actuator 144 may include a heating element and power supply for use with SPEC particles 132 that are configured to react to temperature. In embodiments, the actuator 144 may provide (e.g., selectively provide) a variety of stimuli to force a reaction from a plurality of SPEC particles 132 that react to disparate stimuli. It is to be understood that the scope of the present disclosure encompasses any suitable actuator 144 necessary to force a reaction from any type of SPEC particle 132 (e.g., through pH, temperature, magnetic fields, electric signals, wavelength/intensity of impinging light, et cetera). Furthermore, the stimuli may be constantly, intermittently, and/or selectively applied by the actuator 144. For example, in embodiments where the actuator 144 employs a magnetic field, the actuator 144 may influence magnetic reactive SPEC particle panels 130 as soon as they are positioned within the magnetic field (e.g., placed within the vessel 142). Alternately or additionally, the actuator 144 may detect the presence (e.g., via a sensor, an electrical connection, etc.) of the body 110 and/or SPEC particle panels 130 when placed within the vessel 142. Once the detection is made, the actuator 144 may apply the stimuli.

The receptacle 140 may alternately or additionally include a control 146 to selectively activate the actuator 144. In this manner, the stimuli may be selectively applied to the SPEC particle panels 130 to initiate the change in appearance of the SPEC particle panel 130. The control 146 may be a switch, toggle, knob, button, and/or any other suitable control device.

In embodiments, the vessel 142 may include a lid, and the lid may act as the control mechanism 146. For example, the actuator 144 may be integrated with the lid such that the stimuli is applied and the SPEC particles 132 respond (e.g., begin changing from the first color to the second color) upon closing the lid. It is to be understood that the receptacle may have a plurality of control mechanisms 146, each of which may correspond to a different type of actuator 144. For instance, there may be a first control 146 for actuating a magnetic field and a second control 146 for actuating an electrical impulse.

In embodiments, the receptacle 140 may be configured to fit within and/or form a part of a fishing tackle box, or other transportable container. The receptacle 140 may include (e.g., externally and/or internally to the vessel 142) storage space, such as storage space for alternate/replacement SPEC particle panels 130, one or more fishing lures 100, other fishing tackle and gear, et cetera.

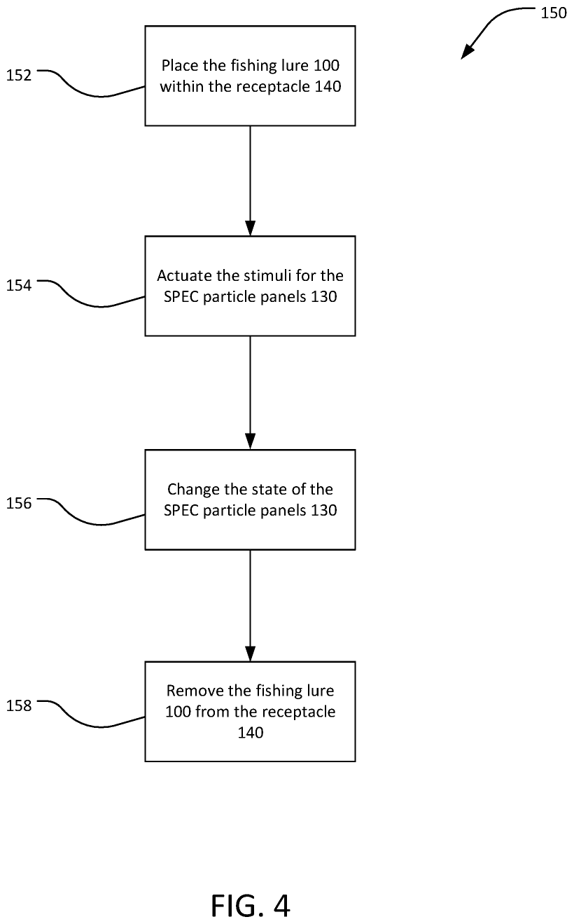

A method 150 for using the receptacle 140 with the fishing lure 100 is depicted in FIG. 4. First, in step 152, the body 110 of the fishing lure 100 with SPEC particle panels 130 may be placed within the vessel 142. During this step, the fishing lure 100 may be situated to ensure proper arrangement between the SPEC particle panels 130 and their corresponding actuator 144. Next, in step 154, the stimuli are applied to the SPEC particle panels 130. For example, the control 146 may be tripped to supply the stimuli and begin the process of switching the SPEC particle panels 130 from one color state to another.

Next, at step 156, the SPEC particle panels 130 may begin changing appearance (e.g., by changing from the first color to the second color). It shall be understood that the SPEC particle panels 130 need not change their color entirely. In some embodiments, the SPEC particle panels 130 may slowly transition from one color to the next, and it may be desirable to leave the SPEC particle panels 130 in a semi-changed state (e.g., a panel 130 that changes between red and blue may be left as half red, half blue). In embodiments, the control mechanism 146 may be configured to maintain the SPEC particle panels 130 in the semi-changed state. Finally, at step 158, the fishing lure 100 may be removed from the receptacle 140, thus precluding any further stimuli influence upon the SPEC particle panel 130. This process may be repeated for each separate SPEC particle panel 130, or for multiple panels 130 at a time.

It shall be understood that the method 150 may have steps omitted, added, and/or modified, and that the order of carrying out these steps may be altered. For example, in embodiments, the step of applying the stimuli (step 154) may be performed without the control mechanism 146, such as when the actuator 144 is configured to constantly provide a stimulus. Further, additional steps for triggering a plurality of control mechanisms 146 to induce a plurality of stimuli via the actuators 144 may be further included as part of the method 150.

In embodiments, the attributes of the SPEC particles 132 may include functional features beyond simply color changing, such as resistive-capacitive timing elements, analog computing devices, and/or digital memory status storage devices. These special features can be used to realize fishing lure 100 functions such as self-flashing fishing lures, bite detection indicators, fishing lure vibrations, synthetic heartbeats, and transceiver modes of supplemental communication (e.g., bite detection relay signaling). For example, a specialized mode of stressed or distressed fish may be emulated by changing patterns of color or vibrations of the fishing lure 100.

One advantage of the various fishing lure embodiments described herein may be that the fishing lure 100 may be adjusted to suit the conditions of a particular fishing task. For example, the user may adjust the fishing lure 100 to account for conditions such as type of fish desired, water depth, type of body of water (e.g., river, lake, pond, etc.), light conditions, et cetera. Conversely, known fishing lures are typically suited for only a narrow range of fishing task conditions. Furthermore, embodiments of the fishing lure 100 that include separable SPEC particle panels 130 may be more readily repaired than non-SPEC particle fishing lures. Yet another advantage of the fishing lure 100 described herein may be that the SPEC particle panels 130 require less energy to operate than known color changing fishing lures, since the SPEC particle panels 130 may require no energy to remain in their state once changed.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims. Not all steps listed in the various figures need be carried out in the specific order described.

What is claimed is:

1. A fishing lure system, comprising:
a fishing lure body having a line attachment portion and a hook; and
a first static programmable electro-chromic (SPEC) particle panel adjacent the body, the first SPEC particle panel being selectively changeable between a first color and a second color in response to a first stimulus.

2. The fishing lure system of claim 1, wherein the first stimulus is selected from the group consisting of an electric impulse, a magnetic field, and a temperature change.

3. The fishing lure system of claim 2, further comprising;
a second SPEC particle panel adjacent the body, the second SPEC particle panel being selectively changeable between a third color and a fourth color in response to a second stimulus.

4. The fishing lure system of claim 3, wherein the second stimulus is disparate from the first stimulus.

5. The fishing lure system of claim 4, wherein the first SPEC particle panel is located at a first area of the body and the second SPEC particle panel is located at a second area of the body.

6. The fishing lure system of claim 1, wherein the first SPEC particle panel is removably coupled to the body.

7. The fishing lure system of claim 6, further comprising:
a second SPEC particle panel removably coupled to the body and being selectively changeable between a third color and a fourth color in response to a second stimulus; and
wherein the second SPEC particle panel is interchangeable with the first static programmable electro-chromic particle panel on the body.

8. The fishing lure system of claim 1, wherein the body is hollow and defines an interior portion.

9. The fishing lure system of claim 9, wherein the body is at least one of translucent and transparent.

10. The fishing lure system of claim 9, wherein the first static programmable electro-chromic particle panel is disposed within the interior portion of the body.

11. A fishing lure system, comprising:
a fishing lure body comprising a first static programmable electro-chromic (SPEC) particle panel selectively changeable between a first color and a second color; and
a receptacle configured to receive the body, the receptacle having an actuator;
wherein:
the first SPEC particle panel changes between the first and the second color in response to a first stimulus; and
the actuator is configured to apply the first stimulus to the first SPEC particle panel.

12. The fishing lure system of claim 11, wherein the actuator further comprises a control mechanism for activating the actuator.

13. The fishing lure system of claim 11, wherein the actuator comprises a sensor configured to detect the first SPEC particle panel, and wherein the actuator applies the first stimulus in response to a first SPEC particle panel detection.

14. The fishing lure system of claim 11, wherein the body further comprises;
a second SPEC particle panel selectively changeable between a third color and a fourth color in response to a second stimulus.

15. The fishing lure system of claim 14, wherein the actuator is further configured to apply the second stimulus to the second SPEC particle panel.

16. A method of operating a fishing lure system, comprising:
providing a fishing lure comprising:
a body comprising a first static programmable electro-chromic (SPEC) particle panel selectively changeable between a first color and a second color in response to a stimulus; and
providing a receptacle configured to house the body, the receptacle having an actuator for actuating a first stimulus;
placing the body within the receptacle;
actuating the first stimulus to initiate the first SPEC particle panel change from the first color to the second color; and
removing the body from the receptacle.

17. The method of claim 16, wherein the first stimulus is selected from the group consisting of an electric impulse, a magnetic field, and a temperature change.

18. The method of claim 16, wherein the fishing lure system further comprises a control mechanism, and wherein the first stimulus is applied by activating the actuator via the control mechanism.

19. The method of claim 16, wherein:
the fishing lure body further comprises a second SPEC particle panel selectively changeable between a third color and a fourth color in response to a second stimulus; and
the method further comprises the steps of:
actuating the second stimulus to initiate the second SPEC particle panel change from the third color to the fourth color.

20. The method of claim 19, further comprising the step of interchanging the first SPEC particle panel with a second SPEC particle panel.
